(19) United States
(12) Patent Application Publication
(10) Pub. No.: US 2010/0209635 A1
(43) Pub. Date: Aug. 19, 2010

(54) METHOD FOR PRESSURIZING THE INTERIOR OF A THIN-WALLED CONTAINER, AND RESULTING PRESSURIZED CONTAINER

(75) Inventor: Jean-Tristan Outreman, Saint Maximin La Sainte Baume (FR)

Correspondence Address: YOUNG & THOMPSON, 209 Madison Street, Suite 500, Alexandria, VA, 22314, US

(73) Assignee: TECSOR HR S.A.S., Meyreuil (FR)

(21) Appl. No.: 12/681,955

(22) PCT Filed: Oct. 9, 2008
(86) PCT No.: PCT/FR08/51825

§ 371 Date: Apr. 7, 2010

(30) Foreign Application Priority Data
Oct. 10, 2007 (FR) 0758188

(51) Int. Cl. B29C 71/02; B29D 22/02

(52) U.S. Cl. 428/34.1; 264/521

(57) ABSTRACT

A process for pressurization of a thin-walled container, designed to contain a flat liquid, includes the following stages:
producing a thin-walled container by generating residual stresses,
filling this container under cold conditions with the flat liquid,
sealing the container after filling, and
heating the wall of the container, without raising the temperature of the liquid, to reach the temperature point for release of the stresses so as to generate a pressurization of the interior of the container. The thus obtained container is also described.

This invention relates to a process for pressurizing the interior of a thin-walled container to impart to it a strong mechanical resistance. The invention also covers the mechanically strong pressurized container that is thus obtained.

The thin-walled containers are known, for example, in the patent applications WO-03/033361, EP-1468930 and EP-1527999.

These containers are very attractive for small volumes of less than 2 liters because beyond this, the products that are produced according to the teaching of these patents are relatively heavy because the amount of material is linked to the volume.

In the case of small volumes and regardless of the process for production of the thin-walled containers, the rigidity of the container is inadequate.

This rigidity is inadequate for allowing good gripping before opening, and primarily this low rigidity makes difficult and even impossible a superposition of these full containers, in particular when they are palletized and the pallets are stacked on one another.

In addition, the rigidity of such a thin-walled container poses another problem because these containers are packaged at ambient temperature and when these containers are placed in a cold environment, a collapsing phenomenon occurs that produces deformations of the container.

As a result, when the thin-walled containers are filled under cold conditions with flat liquids such as mineral water, oil, fruit juices, or milk, an installation is used that necessarily works aseptically.

Then, to meet the requirement of rigidity, it is provided to put these thin-walled containers under internal pressure by resorting in particular to the so-called nitrogen drop process that is currently used industrially.

This process consists in introducing a drop of liquid nitrogen into the liquid-filled container to be packaged immediately before the head space of the container is sealed.

Immediately after sealing, this drop of liquid nitrogen is transformed into gas. The increase in volume in the head space leads to a rise in pressure in the interior of the container and therefore to a rigidification of said container. This increase in pressure nevertheless remains relatively low on the order of one-tenth of a bar.

However, this process of the nitrogen drop poses a certain number of problems.

First of all, the metering of the volume that is introduced is difficult; however, the final pressure depends on the amount that is introduced, the working conditions, and the length of time of sealing.

Then, the distribution means of this drop of nitrogen should be integrated in the chain, and, as a result, they should therefore be suitable for operating in an aseptic environment, which is a significant stress: requirements of cleaning, sterilization, maintenance. An additional station involves an additional source of failure with the stopping of a chain on which intervention is difficult and time-consuming because it is necessary to restore the unit to aseptic packaging conditions.

In addition, it is noted that the liquid nitrogen, at a highly negative temperature, drops in the liquid to ambient temperature although the fall of the drop uniformly causes splashing on the edges of the container.

These splashes of the contained fluid, such as mineral water, fruit juice, and oil, can degrade after packing, during the storage, leading to the development of mold before the product is marketed and therefore before the product is consumed, which is not satisfactory.

The material that is used for the production of the thin-walled containers is often PET, polyethylene terephthalate, known for its transparency, its low weight, and its great shaping possibilities. The PET also allows good preservation of contained liquids.

This invention proposes a process for pressurization of the interior of a thin-walled container, filled under cold conditions and containing a flat liquid so as to increase the rigidity of said container before opening, a process that compensates for the problems that are mentioned above.

According to the invention, the thin-walled container is of the type that is manufactured in a known way by blowing from a preformed shape.

This container has the necessary and desired volume.

In contrast, residual manufacturing stresses remain. Actually, in the case of PET, in particular, once the preformed shape is blown, the container is cooled very quickly in the molds. The shape that is obtained and the stresses that are linked to the deformation are created by this lowering of temperature.

Actually, during the blowing process, the stresses are exerted in two directions, longitudinal and radial, hence the name of bi-oriented PET container given to the containers that are thus obtained.

It is this setting at a temperature that is less than the glass transition temperature that secures for the container the preservation of the shape.

In this case, according to a nonlimiting embodiment, the thin-walled container that is obtained has a material weight/wall surface ratio on the order of 150 g/m² to 250 g/m² and more particularly from 150 g/m² to 200 g/m².

The process for pressurization, according to this invention, of a thin-walled container, designed to contain a flat liquid, consists of the series of the following stages:
Production of a thin-walled container by generating residual stresses,
Filling this container under cold conditions with said flat liquid,
Sealing the container after filling, and
Heating the wall of the container, without raising the temperature of the liquid, to reach the temperature point for release of said stresses so as to generate a pressurization of the interior of said container.

The purpose of this last so-called heating stage of the wall is to heat only the wall taken in its thickness. This heat input causes the release of stresses that had been created by the rapid cooling after deformation during manufacturing.

In the case of a blown PET container, the residual stresses are bi-oriented. The container therefore has a tendency to resume its initial shape, i.e., that of the preformed shape.

Because of this tendency toward a volumetric reduction, the interior of the container is pressurized and since the liquid is incompressible, the head space is compressed until a balance is reached between the pressure exerted by the wall and the inner pressure.

The thus generated inner pressure is on the order of tenths of bars but this pressure is absolutely adequate for considerably increasing the rigidity of the filled and sealed container before its first sealing.

Such heating can be implemented by means of spraying hot air on the periphery of the container for a short period of time. It is advisable to reach the temperature point that causes the release of the stresses in the material, a point known also under the name of glass transition point.

The heat energy input should be significant over a very short period.

Thus, the PET, which is a poor conductor of heat, absorbs calories supplied by hot air, which leads to a rapid release of the stresses and prevents the transmission of calories to the liquid or at least makes the amount of transmitted calories totally negligible.

Actually, in the case of heating and a temperature rise of the liquid mass that is contained, it is known that this causes, in cooling, a reduction of the volume of the head space that is reflected by a collapse of the bottle. Actually, the inner pressure decreases while the container has seen its volume created, and then the release of the stresses is also created with the lowering of the temperature below the glass transition point.

The inner pressurization according to the process of this invention also makes it possible to compensate for the reduction in pressure, low but able to exist, linked to the loss of a portion of the liquid because of the permeability of the walls, these walls being very thin.

The pressurization of the interior of the container thus makes it possible to compensate for the collapse that is linked to a temperature decrease between the packaging temperature and the storage temperature, before opening.

The thus used process is extremely industrializable with very limited costs, very small breakdown risks, and an absolutely satisfactory reproducibility since it is self-regulated.

Primarily, the rigidification processing by heat is conducted outside of the chain with an aseptic environment, which is a considerable gain.

The thin-walled containers that are thus produced, having wall thicknesses such that the material weight/surface ratio is between 150 g/m² and 250 g/m², more particularly between 150 g/m² and 200 g/m², can withstand large loads because of their greatly increased rigidity; in particular, such containers can be palletized, and the pallets themselves can be stacked.

From the sanitary standpoint, it should also be noted that the guarantee of the preservation of qualities imparted to the liquid during bottling cannot be disputed since the heating operation is outside of the bottling chain in an aseptic environment and is implemented on a closed container.

Even a possible contamination source is eliminated since the station that allows the pressurization of the interior of the container is withdrawn from the working zone in an aseptic environment.

The heating—of which it is indicated that a preferred embodiment is that of hot air—can also resort to infra-red heating.

Likewise, the material in question is PET because it is currently the most used, but this invention relates to any suitable material for producing a container, able to exhibit residual stresses and obtained from deformation.

1. Process for pressurization of a thin-walled container, designed to contain a flat liquid, characterized in that it consists of the series of the following stages:
Production of a thin-walled container by generating residual stresses,
Filling this container under cold conditions with said flat liquid,
Sealing the container after filling, and
Heating the wall of the container, without raising the temperature of the liquid, to reach the temperature point for release of said stresses so as to generate a pressurization of the interior of said container.

2. Process for pressurization of a container according to claim 1, wherein the production of a thin-walled container consists of a blowing process.

3. Process for pressurization of a container according to claim 1, wherein the heating of the sealed container is carried out by blowing hot air.

4. Process for pressurization of a container according to claim 1, wherein the filling of the container is carried out in an aseptic environment.

5. Process for pressurization of a container according to claim 1, wherein the thin-walled container comprises a material weight/surface ratio of said container of between 150 g/m² and 250 g/m², more particularly between 150 g/m² and 200 g/m².

6. Process for pressurization of a container according to claim 1, wherein the material is polyethylene terephthalate or PET.

7. Process for pressurization of a container according to claim 1, wherein the flat liquid is mineral water, oil, fruit juice, or milk.

8. Thin-walled container that is obtained from the process according to claim 1, wherein it comprises an inner overpressure of several tenths of bars.

9. Container according to claim 8, wherein it has a material weight/surface ratio of between 150 g/m² and 250 g/m².

10. Container according to claim 9, wherein it has a material weight/surface ratio of between 150 g/m² and 200 g/m².

11. Process for pressurization of a container according to claim 2, wherein the heating of the sealed container is carried out by blowing hot air.
